(19) United States
(12) Patent Application Publication
(10) Pub. No.: US 2016/0276090 A1
(43) Pub. Date: Sep. 22, 2016

(54) COIL COMPONENT AND METHOD OF MANUFACTURING THE SAME

(71) Applicant: Samsung Electro-Mechanics Co., Ltd., Suwon-si (KR)

(72) Inventors: Jin-Gu KIM, Suwon-si (KR); Ichiro OGURA, Suwon-si (KR); Hong-Won KIM, Suwon-si (KR); Sang-Moon LEE, Seoul (KR); Kwang-Jik LEE, Seongnam-si (KR); Myung-Jae YOO, Ulsan (KR)

(73) Assignee: Samsung Electro-Mechanics Co., Ltd., Suwon-si (KR)

(21) Appl. No.: 15/072,812

(22) Filed: Mar. 17, 2016

(30) Foreign Application Priority Data
Mar. 18, 2015 (KR) 10-2015-0037443

(51) Int. Cl. H01F 27/255; H01F 41/04; H01F 41/02; H01F 41/10; H01F 27/28; H01F 27/29

(52) U.S. Cl. CPC H01F 27/255; H01F 27/2804; H01F 27/29; H01F 41/0246; H01F 41/10; H01F 41/041

(57) ABSTRACT

A coil component and a method of manufacturing a coil component are disclosed. The coil component includes an insulation layer including a coil conductor, and a magnetic-resin composite layer disposed on the insulation layer. The magnetic-resin composite layer includes a magnetic core.

### CROSS-REFERENCE TO RELATED APPLICATIONS

This application claims the benefit under 35 USC 119(a) of Korean Patent Application No. 10-2015-0037443, filed with the Korean Intellectual Property Office on Mar. 18, 2015, the disclosure of which is incorporated herein by reference in its entirety.

### BACKGROUND

1. Field

The following description relates to a coil component and a method of manufacturing the coil component having a high magnetic permeability.

2. Description of Related Art

With the advancement in technology, electronic devices, such as mobile phones, home electronic appliances, personal computers, personal digital assistants (PDA) and liquid crystal displays (LCD), have transformed from being analog to being digital and have become increasingly faster due to the increased amount of processed data.

Accordingly, high-speed interfaces, such as universal serial bus (USB) 2.0, USB 3.0 and a high-definition multimedia interface (HDMI), have been widely used in various digital devices, including personal computers and high-definition digital television.

Unlike the single-end transmission systems, which have been conventionally used for a long time, these high-speed interfaces adopt a differential signal system transmitting differential signals (differential mode signals) using a pair of signal lines. However, as the electronic devices are faster in processing time, these devices are more sensitive to stimulation from an external environment, such as noise. As a result, signal distortions often occur in the electronic devices. The signal distortions are normally produced by a high-frequency noise.

A filter is often installed in the electronic devices in order to remove such noise. The filter is popularly used as a coil component to remove a common mode noise in a high-speed differential signal line as a common mode filter (CMF). As the common mode noise is a noise generated in a differential signal line, the common mode filter removes the common mode noise that cannot be removed using a conventional filter.

Meanwhile, as today's electronic products have become increasingly faster, multi-functional and higher-performance oriented, a higher magnetic permeability is required for the coil components used in these electronic products. One of the most universal measures to satisfy the higher permeability requirement is to increase a number of turns of coils by providing a finer space between the coils.

However, increasing the number of coil turns is not easily feasible when manufacturing ultra-small coil components, such as 1005 (1.0 mm×0.5 mm×0.5 mm), 0603 (0.6 mm×0.3 mm×0.3 mm) and 0403 (0.4 mm×0.3 mm×0.3 mm), and complicates the manufacturing process, thereby increasing the manufacturing costs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is a coil component, including: an insulation layer including a coil conductor; and a magnetic-resin composite layer disposed on the insulation layer, wherein the magnetic-resin composite layer may include a magnetic core.

The magnetic core may penetrate a middle portion of the magnetic-core composite layer.

The magnetic core may be a sintered ferrite.

The magnetic core may be extended toward the insulation layer and a portion thereof is sunk in the insulation layer.

The magnetic core may penetrate the insulation layer, and the coil conductor is wound about the magnetic core.

The coil component may also include external electrodes disposed at upper outer corners of the insulation layer, wherein the magnetic-resin composite layer is formed in between the external electrodes.

The coil component may also include a magnetic substrate disposed below the insulation layer.

The coil conductor may include a first coil and a second coil electromagnetically coupled to each other.

In accordance with an embodiment, there is provided a method of manufacturing a coil component, including: forming an insulation layer including a coil conductor; disposing a magnetic core at an upper middle portion of the insulation layer; and forming a magnetic-resin composite layer above the insulation layer.

Prior to the disposing of the magnetic core, a groove is formed at a portion of the insulation layer, and further including: inserting and disposing the magnetic core in the groove.

The groove may be formed to penetrate the insulation layer.

The magnetic-resin composite layer may be formed by coating a magnetic-resin paste or laminating a magnetic-resin film.

The method may also include forming external electrodes at upper outer corners of the insulation layer, prior to the forming of the magnetic-resin composite layer.

The method may also include prior to the forming of the insulation layer, obtaining a magnetic substrate, wherein, the insulation layer including the coil conductor is formed above the magnetic substrate.

In accordance with another embodiment, there is provided a method to form a coil component, including: preparing a substrate by sintering magnetic powder; laminating and forming an insulation layer on the substrate, wherein the insulation layer may include a coil conductor; forming a groove at an upper portion of the insulation layer; inserting the magnetic core into the groove; forming external electrodes at outer corners above the insulation layer, wherein the external terminals comprise a same height as a height of the magnetic core and are positioned near corners of the insulation layer; and forming a magnetic-resin composite layer above the insulation layer.

The method may also include coating the insulation material on an upper surface of the substrate in order to mitigate a surface roughness of the substrate, and forming one layer of the coil conductor on the coated insulation layer.

The magnetic core may penetrate an upper center portion of the magnetic-resin composite layer.

The magnetic core may penetrate an upper off-center portion of the magnetic-resin composite layer.

The magnetic core may be solid.

The magnetic core may extend from an upper surface of the magnetic-resin composite layer toward the insulation layer, where a portion of the magnetic core is sunk in the insulation layer. Other features and aspects will be apparent from the following detailed description, the drawings, and the claims.

### BRIEF DESCRIPTION OF DRAWINGS

FIG. 1 is a perspective view showing a coil component, in accordance with an embodiment.

FIG. 2 is a sectional view of the coil component shown in FIG. 1 along an I-I′ line.

FIG. 3 is a sectional view showing a coil component, in accordance with another embodiment.

FIG. 4 is a sectional view showing a coil component, in accordance with yet another embodiment.

FIG. 5 is a flow diagram showing a method of manufacturing a coil component, in accordance with an embodiment.

FIG. 6, FIG. 7, FIG. 8, FIG. 9, FIG. 10 and FIG. 11 illustrate various phases of the coil component in accord with functions executed by the method of manufacturing a coil component, in accord with an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art. The terms used in the description are intended to describe certain embodiments. Unless clearly used otherwise, expressions in a singular form include the meaning of a plural form. Any characteristic, number, step, operation, element, part or combinations thereof used in the present description shall not be construed to preclude any presence or possibility of one or more other characteristics, numbers, steps, operations, elements, parts or combinations thereof.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

Hereinafter, certain embodiments are described in detail with reference to the accompanying drawings.

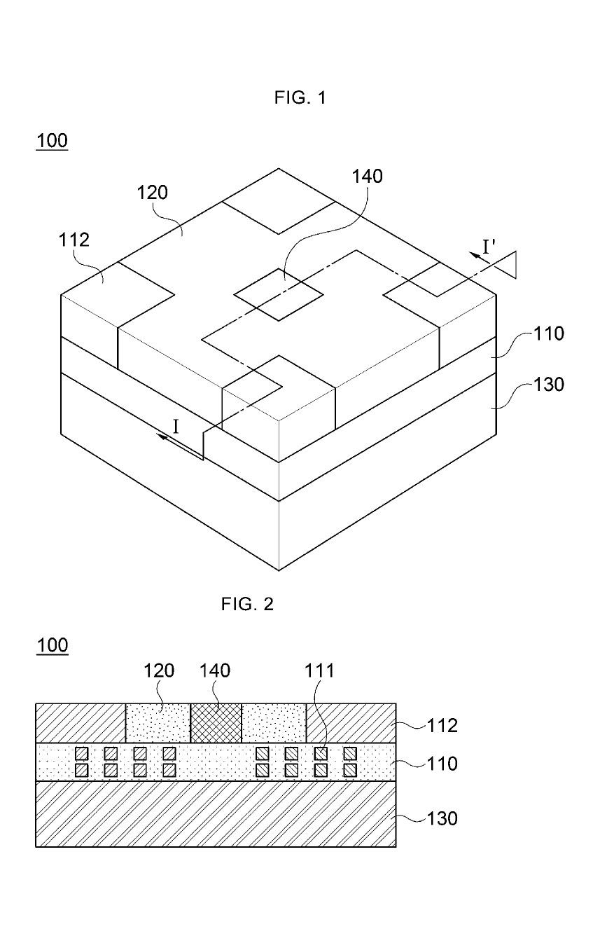

FIG. 1 is a perspective view showing a coil component in accordance with an embodiment. FIG. 2 is a sectional view of the coil component shown in FIG. 1 along an I-I′ line.

Referring to FIG. 1 and FIG. 2, a coil component 100, in accordance with an embodiment, includes an insulation layer 110 having a coil conductor 111 installed therein and a magnetic resin composite layer 120 disposed on the insulation layer 110.

The insulation layer 110 is formed to envelop and embed the coil conductor 111 therein so as to provide insulation between the coil conductor 111 and another coil conductor 111 and protect the coil conductor 111 from an external condition such as moisture or heat. Accordingly, the insulation layer 110 is made of a material having good heat-resisting and moisture-resisting properties as well as an insulating property, for example, epoxy resin, phenol resin, urethane resin, silicon resin or polyimide resin.

In an example, the insulation layer 110 is formed by forming a base layer to provide a base and a flatness and then successively laminating the coil conductor 111 and a build-up layer of the insulation layer 110 covering the coil conductor 111. However, as illustrated, a boundary between layers may be integrated unidentifiably during high-temperature, high-pressure laminating and firing processes.

The coil conductor 111, which is a coil pattern of metal wire formed on a plane in a spiral form, is made of at least one of highly electrically conductive metals including, but not limited to, silver (Ag), palladium (Pd), aluminum (Al), nickel (Ni), titanium (Ti), gold (Au), copper (Cu) and platinum (Pt).

The coil conductor 111 is formed in a multilayered structure, in which plural coil conductors are separated from one another at a predetermined distance on a same layer, and laminated repeatedly in a thickness direction. The coil conductors 111 on different layers are disposed to face opposite to each other in vertical directions to form a coil by making an interlayer connection through a via or other connecting structural element.

In an example, the coil conductor 111 is formed with a first coil and a second coil, which are electromagnetically coupled to each other and are each forming an individual coil. For instance, the first coil and the second coil are electromagnetically coupled to each other and are disposed above and below each other or are alternately disposed on a same layer. Accordingly, the coil component 100 operates as a common mode filter (CMF) in which the magnetic flux is reinforced when a current is applied to the first coil and the second coil in a same direction and in which the magnetic flux is canceled out. A differential mode impedance is decreased when the current is applied to the first coil and the second coil in opposite directions.

The insulation layer 110 is laminated with a magnetic substrate 130 disposed under the insulation layer 110. That is, the magnetic substrate 130 is a plate-type support having a high modulus.

Moreover, the magnetic substrate 130 becomes a moving path of magnetic flux generated around the coil conductor 111 when a current is applied. Accordingly, the magnetic substrate 130 is made of any magnetic material as long as a predetermined inductance is obtained, for example, a Ni-based ferrite material having Fe₂O₃ and NiO as main components, a Ni—Zn ferrite material having Fe₂O₃, NiO and ZnO as main components, or a Ni—Zn—Cu ferrite material having Fe₂O₃, NiO, ZnO and CuO as main components.

In order to better facilitate the flow of magnetic flux, a magnetic member may be further provided above the insulation layer 110. However, because pad types of external electrodes 112 are formed to be externally exposed and electrically connect to an external electrical element at outer corners above the insulation layer 110, it would be difficult to dispose a solid type of magnetic member. A fluid type of magnetic member, such as a magnetic-resin composite layer 120, is instead filled in an empty space among the external electrodes 112.

The magnetic-resin composite layer 120 is made of a polymer resin having magnetic powder contained therein as a filler. As a result, the magnetic-resin composite layer 120 has a high magnetic permeability depending on a content ratio and a size of the magnetic powder. Generally, the larger the magnetic powder, the higher the magnetic permeability. However, an excessive size of the magnetic powder inhibits the magnetic powder from flowing easily to a point of possibly lowering a filling rate and causing a void inside the magnetic-resin composite layer 120.

Accordingly, the coil component 100, in accordance with an embodiment, has a magnetic core 140 inserted in the magnetic-resin composite layer 120 to provide a high magnetic permeability without an occurrence of a defect such as the void. In one configuration, the magnetic core 140 is made of sintered ferrite that is manufactured by sintering magnetic powder, such as Ni-based ferrite, Ni—Zn ferrite or Ni—Zn—Cu ferrite, and is disposed or positioned to penetrate a center of the magnetic-resin composite layer 120. In accordance with an alternative configuration, the magnetic core 140 is disposed or positioned to penetrate an off-center location of the magnetic-resin composite layer 120.

As such, in an embodiment in which the magnetic core 140 is provided as a solid, the magnetic permeability is prevented from falling, by inhibiting an increase of coercive force caused by domain wall pinning. Moreover, when a current is applied, magnetic flux generated around the coil conductor 111 passes through the magnetic-resin composite layer 120 and the magnetic substrate 130 at an upper portion and a lower portion of the coil conductor 111 and through the magnetic core 140 at a middle portion of the core conductor 111, thereby forming a closed magnetic circuit. As a result, a continuity of the magnetic flux is maintained to realize a high magnetic permeability.

As such, in the core component 100, in accordance with an embodiment, a high magnetic permeability is guaranteed by the magnetic core 140. As a result, it is possible to simplify a structural configuration of the coil component and manufacturing process thereof, compared to the conventional structure in which the magnetic permeability has been raised by increasing the number of coil turns. Accordingly, a yield is improved and the production costs are lowered. Moreover, with the configuration of, at least, the magnetic core 140, the magnetic-resin composite layer 120 is realized to have a high density and a high filling rate, by properly adjusting a size of the magnetic powder contained in the magnetic-resin composite layer 120.

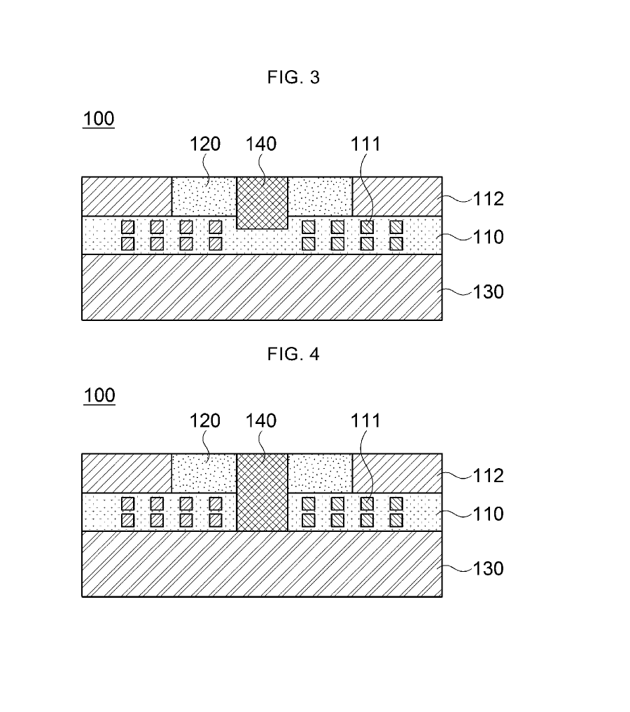

FIG. 3 is a sectional view showing a coil component, in accordance with another embodiment.

Referring to FIG. 3, the magnetic core 140, in accordance with an embodiment, is extended from an upper surface of the magnetic-resin composite layer 120 toward the insulation layer 110 such that a portion of the magnetic core 140 is sunk in the insulation layer 110. That is, the magnetic core 140 is disposed by being inserted in a groove formed on an upper surface of the insulation layer 110, through the magnetic-resin composite layer 120.

As the magnetic permeability increases in proportion to the size of the magnetic core 140, the more the portion of the magnetic core 140 sinks in the insulation layer 110, the more the coil property is improved. Accordingly, as shown in FIG. 4, the magnetic core 140 is penetrates the insulation layer 110, depending on the specifications and use of the product, in which case the coil conductor 111 is wound about the magnetic core 140.

Moreover, the above structure allows the coil component 100 to be manufactured easily, which will be described later in detail when a method of manufacturing a coil component is described.

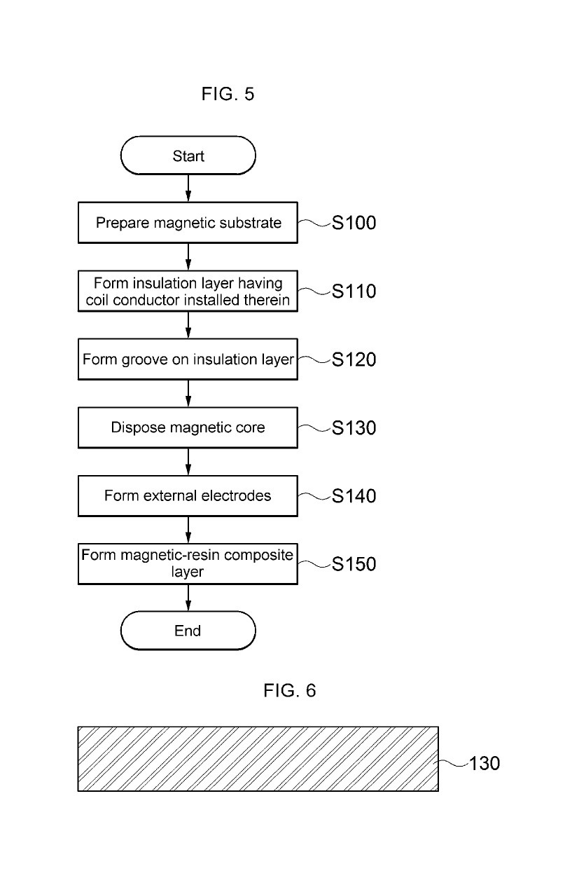

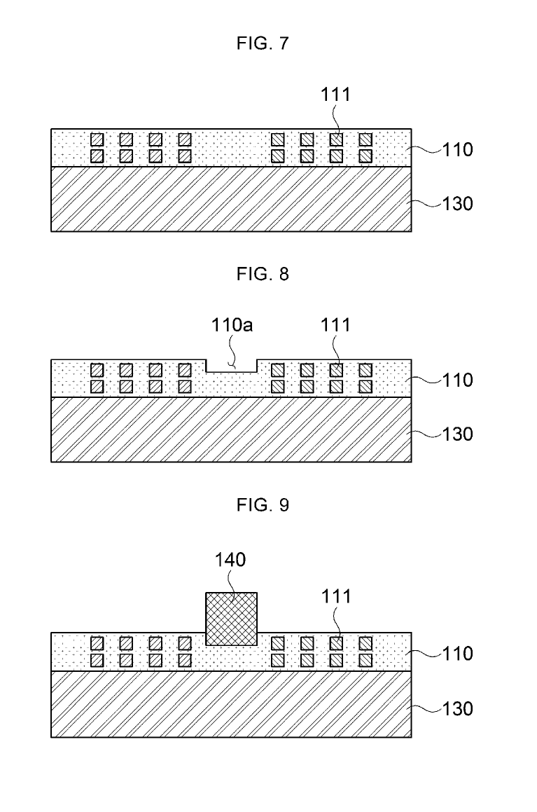

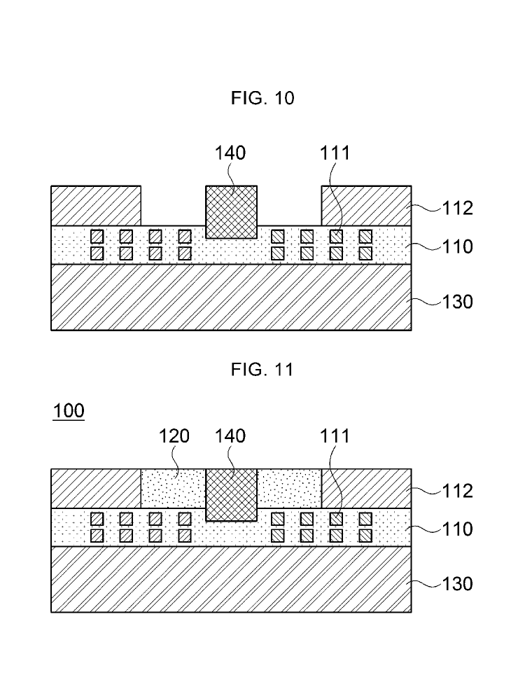

FIG. 5 is a flow diagram showing a method of manufacturing a coil component, in accordance with an embodiment. FIG. 6, FIG. 7, FIG. 8, FIG. 9, FIG. 10 and FIG. 11 illustrate various phases of the coil component in accord with functions executed by the method of manufacturing a coil component, in accord with an embodiment.

As shown in FIGS. 5 and 6, the method of manufacturing a coil component, in accordance with an embodiment, begins at operations S100, by preparing a magnetic substrate 130 by sintering magnetic powder under predetermined conditions.

Then, as shown in FIGS. 5 and 7, at operation S110, an insulation layer 110 having a coil conductor 111 installed therein is laminated and formed on the magnetic substrate 130.

For instance, an insulation material is coated on an upper surface of the magnetic substrate 130 in order to mitigate a surface roughness of the magnetic substrate 130, and one layer of coil conductor 111 is formed on the coated insulation layer using a plating process, for example, the semi-additive process (SAP), the modified semi-additive process (MSAP) or the subtractive process. Afterwards, an insulation material is coated again to cover the coil conductor 111. The operations described above are repeated until the required number of layers of coil conductor 111 is reached. Then, by sintering the laminated insulation material and coil conductor 111, the insulation layer 110 having the coil conductor 111 installed therein is completed.

As shown in FIGS. 5 and 8, at operation S120, before disposing a magnetic core 140 at an upper middle portion of the insulation layer 110, a groove 110a is formed at a portion of the insulation layer 110 where the magnetic core 140 is to be disposed. Although it is illustrated herein that the groove 110a is formed with a predetermined depth, based on an embodiment shown in FIG. 3, the groove 110a may be formed to penetrate the insulation layer 110, in which case the coil component, in accordance with an embodiment illustrated in FIG. 4 may be manufactured.

Then, as illustrated in FIGS. 5 and 9, at operation S130, the magnetic core 140 is inserted into the groove 110a. By disposing the magnetic core 140 after forming the groove 110a on the insulation layer 110, it is possible to not only align the position of the magnetic core 140 readily, but also prevent a defect caused by position variations of the magnetic core 140 because follow-up processes may be performed while the magnetic core 140 is fixed in the groove 110a.

Thereafter, as shown in FIGS. 5 and 10, at operation S140, external electrodes 112 are formed at outer corners above the insulation layer 110.

The external terminals 112 are formed with a same height as that of the magnetic core 140 using a common plating process. In one illustrative example, a total of four external electrodes 112, including a pair of external terminals connected to either end of a first coil of the coil conductor 111. The pair of the external terminals respectively function as input and output terminals of the first coil. Another pair of external terminals is connected to either end of a second coil and respectively function as input and output terminals of the second coil. Both pairs of external terminals are positioned near four corners of the insulation layer 110, in a clockwise or counterclockwise direction, from an upper left corner of the insulation layer 110.

Lastly, as shown in FIGS. 5 and 11, at operation S150, the coil conductor, in accordance with an embodiment, is completed by forming a magnetic-resin composite layer 120 above the insulation layer 110.

The magnetic-resin composite layer 120 is formed by filling and drying a magnetic-resin paste, which is manufactured by impregnating polymer resin in a magnetic powder, in an empty space in between the external electrodes 112 and the magnetic core 140 or by laminating a magnetic-resin film, which is manufactured by semi-hardening the magnetic-resin paste to a film form, on the insulation layer 110.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil component, comprising:
an insulation layer comprising a coil conductor; and
a magnetic-resin composite layer disposed on the insulation layer,
wherein the magnetic-resin composite layer comprises a magnetic core.

2. The coil component as set forth in claim 1, wherein the magnetic core penetrates a middle portion of the magnetic-core composite layer.

3. The coil component as set forth in claim 1, wherein the magnetic core is a sintered ferrite.

4. The coil component as set forth in claim 1, wherein the magnetic core is extended toward the insulation layer and a portion thereof is sunk in the insulation layer.

5. The coil component as set forth in claim 1, wherein the magnetic core penetrates the insulation layer, and the coil conductor is wound about the magnetic core.

6. The coil component as set forth in claim 1, further comprising:
external electrodes disposed at upper outer corners of the insulation layer,
wherein the magnetic-resin composite layer is formed in between the external electrodes.

7. The coil component as set forth in claim 1, further comprising:
a magnetic substrate disposed below the insulation layer.

8. The coil component as set forth in claim 1, wherein the coil conductor comprises a first coil and a second coil electromagnetically coupled to each other.

9. A method of manufacturing a coil component, comprising:
forming an insulation layer comprising a coil conductor;
disposing a magnetic core at an upper middle portion of the insulation layer; and
forming a magnetic-resin composite layer above the insulation layer.

10. The method as set forth in claim 9, wherein, prior to the disposing of the magnetic core, a groove is formed at a portion of the insulation layer, and further comprising:
inserting and disposing the magnetic core in the groove.

11. The method as set forth in claim 10, wherein the groove is formed to penetrate the insulation layer.

12. The method as set forth in claim 9, wherein the magnetic-resin composite layer is formed by coating a magnetic-resin paste or laminating a magnetic-resin film.

13. The method as set forth in claim 9, further comprising:
forming external electrodes at upper outer corners of the insulation layer, prior to the forming of the magnetic-resin composite layer.

14. The method as set forth in claim 9, further comprising, prior to the forming of the insulation layer, obtaining a magnetic substrate,
wherein, the insulation layer comprising the coil conductor is formed above the magnetic substrate.

15. A method to form a coil component, comprising:
preparing a substrate by sintering magnetic powder;
laminating and forming an insulation layer on the substrate, wherein the insulation layer comprises a coil conductor;
forming a groove at an upper portion of the insulation layer;
inserting the magnetic core into the groove;
forming external electrodes at outer corners above the insulation layer, wherein the external terminals comprise a same height as a height of the magnetic core and are positioned near corners of the insulation layer; and
forming a magnetic-resin composite layer above the insulation layer.

16. The method as set forth in claim 15, further comprising:
coating the insulation material on an upper surface of the substrate in order to mitigate a surface roughness of the substrate, and
forming one layer of the coil conductor on the coated insulation layer.

17. The method as set forth in claim 15, wherein the magnetic core penetrates an upper center portion of the magnetic-resin composite layer.

18. The method as set forth in claim 15, wherein the magnetic core penetrates an upper off-center portion of the magnetic-resin composite layer.

19. The method as set forth in claim 15, wherein the magnetic core is solid.

20. The method as set forth in claim 15, wherein the magnetic core extends from an upper surface of the magnetic-resin composite layer toward the insulation layer, where a portion of the magnetic core is sunk in the insulation layer.
